(19) United States
(12) Patent Application Publication
(10) Pub. No.: US 2006/0136372 A1
(43) Pub. Date: Jun. 22, 2006

(54) Inserted contextual web content derived from intercepted web viewing content

(76) Inventor: Alan J. Schunemann, Annapolis, MD (US)

Correspondence Address: DLA PIPER RUDNICK GRAY CARY US LLP, P. O. BOX 9271, RESTON, VA, 20195, US

(21) Appl. No.: 11/283,047

(22) Filed: Nov. 21, 2005

Related U.S. Application Data
(60) Provisional application No. 60/629,304, filed on Nov. 19, 2004.

(51) Int. Cl. G06F 17/30

(52) U.S. Cl. 707/2

(57) ABSTRACT

A method and a system for providing content including intercepting data inbound to a user, data outbound from the user or both. The data is intercepted at a network segment. The method further includes determining content of interest to the user and adding the content of interest to the inbound data.

This application is based on and derives the benefit of the filing date of U.S. Provisional Patent Application No. 60/629,304 filed Nov. 19, 2004, the contents of which are incorporated herein by reference.

### FIELD OF THE INVENTION

The present invention relates generally to computer networking environments, and relates specifically to inserted web content derived from intercepted web viewing content.

### BRIEF DESCRIPTION OF THE DRAWINGS

FIG. 1 is a schematic network system diagram, according to an embodiment of the present invention;

FIGS. 2A-2E depict various configurations of connecting a content insertion engine in a network, according to various embodiments if the present invention;

FIG. 3A-3D show various configuration of connecting a content insertion engine in a network, according to other embodiments of the present invention; and

FIG. 4 is a flow chart showing the functions of the various devices in the network and the inter-relationship between the devices, according to an embodiment of the present invention.

### DESCRIPTION OF EMBODIMENTS OF THE INVENTION

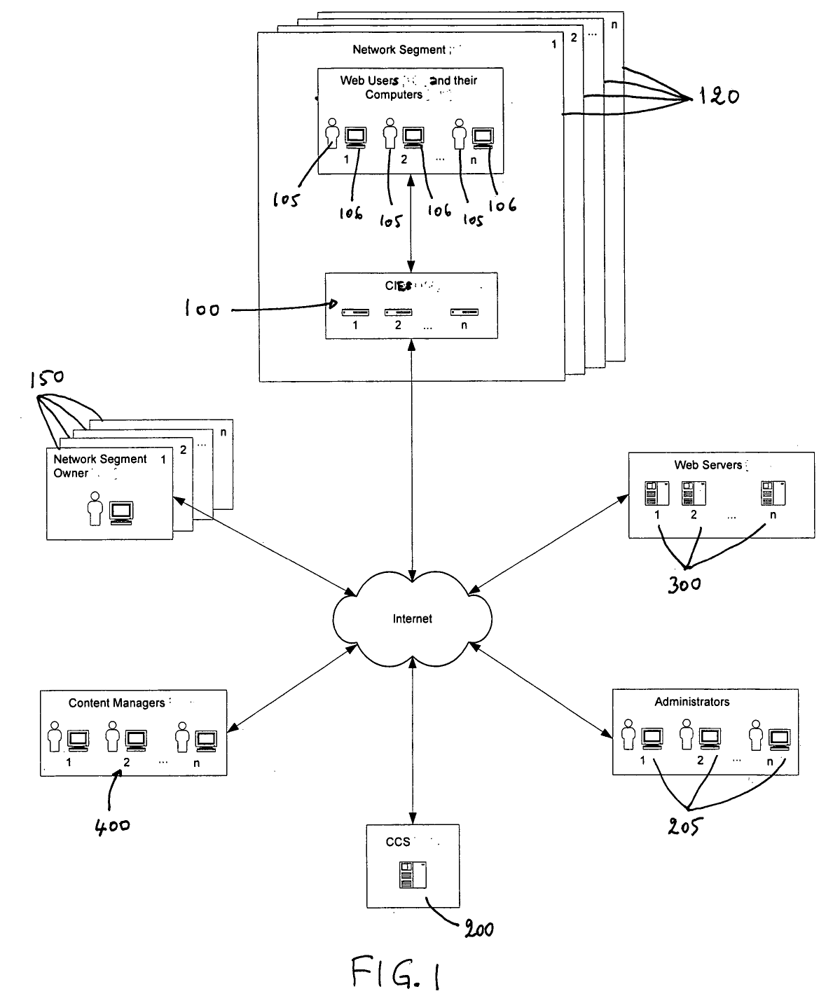

An aspect of an embodiment of the present invention (see, for example FIG. 1) is to enable owners of network bandwidth (network segment 120), such as Wi-Fi™ hotspots in coffee shops, book stores, etc., to generate revenue by selling advertising space that is inserted in the web pages viewed by their network users (web users WU 105). The advertisements are inserted by a device (content insertion engine CIE 100) that the owner (NSO 150) deploys on their network. The device may be implemented as software integrated within a switch, router or other network device or may be a stand alone hardware device. The CIE device sits “inline” in the network traffic stream and transparently monitors and inserts advertisements into web pages requested by the network users.

The network owners (NSO 150) register their device, advertisement space (e.g., 4 cells at the top of web page), its location, demographic information, and other advertisement display conditions with a centralized system (CCS 200) over the internet. This process registers the available advertisement space (supply) with the central management system (CCS 200).

Buyers of advertisement space or advertisers (CM 400) may access the central management system (CCS 200) over the internet using a web browser to buy advertisement space that has been registered by the network owners (NSO 150). The advertisers (CM 400) enter their ads, keywords for matching advertisement with content viewed by network users (WU 105), demographic target parameters, and other content assignment conditions including price in the central management system (CCS 200). The central management system (CCS 200) matches advertisement space with advertisements using these and other parameters (e.g., price, location, demographics, web page content, duration, etc.). In this scenario, buyers of advertising space (CM 400) and sellers of advertising space (NSO 150) buy and sell within the central management system (CCS 200) using a number of market pricing setting schemes (e.g., fixed price, auction, etc.).

For example, location based content can be delivered to the web user (WU 105). For example, if the web user (WU 105) is using his/her computer (WUC 106) at an airport in Chicago and the airport network (NS 120) has one or more CIEs 100 installed on the network, an advertisement for a hotel or restaurant in the city can be sent to the web user. In addition, the MAC address of the web user's computer (WUC 106) can be stored with a time stamp, location, keywords from their web page access, and the content delivered. As the user moves from one network location to another network (e.g. in a different city), the movement can be tracked. If the user movement contains patterns, content targeted at this type of movement can be delivered. For example, advertisement relating to flight travel may be delivered according to the pattern.

Another aspect of an embodiment of the present invention is to deploy the content insertion system within an enterprise's network. For example, in this case, the intercepting and insertion device (CIE 100) and the content control system (CCS 200) may be deployed on the same hardware. For example, the enterprise can use the system to insert messages in every employee's or an individual employee's or group of employees' web browser as the they access internet web sites from the corporate network.

FIG. 1 is a schematic diagram of a network system, according to an embodiment of the invention. The network system 10 comprises one or more network segments (NS) 120. The network segment 120 may be, for example, a local area network or a sub-network within a wide area network (WAN). For example, network segment NS 120 may be a local area network in a coffee shop, airport, enterprise and the like. Each network segment 120 may include one or more web users (WU) 105, each being associated with a respective computer or other networking device 106. The device 106 allows each web user 105 to access its associated network segment 120.

Each network segment 120 further includes one or more content insertion engine (CIE) 100. A content insertion engine is a computing device containing transparent proxy software for intercepting requested web content by the web user 105 and inserting web content or other content to a web page viewed by the web user WU 105. The content insertion engine CIE 100 tracks a number of activity statistics, including a number of unique web users 105, a number of pages viewed by each user 105, a number of advertisements delivered to the web user 105, etc.

The content insertion engine CIE 100 is connected inline on the network at each network segment 120 such that target network traffic passes through the CIE device 100. For example, the content insertion engine CIE 100 may be connected between switches and access points. The content insertion engine CIE device 100 can be implemented as dedicated hardware or may be also implemented as software that when executed by the CIE hardware performs the desired content insertion functions. For example, the CIE 100 may be implemented as a hardware platform such as application-specific integrated circuits (ASICs) in a router blade or the like. The CIE 100 may also be implemented as software and integrated into a device (e.g., switching device) as software. Hence, the content insertion engine CIE 100 may be deployed as software or hardware on existing network devices, such as third party owned devices, that have network traffic flowing through them. For example, the content insertion engines CIE 100 may be deployed at wireless local area network (WLAN) access points (Wi-Fi™ access points) or at routers, or other networking devices that allow access to the internet.

Each network segment 120 is owned by a network segment owner (NSO) 150 (e.g., a coffee shop owner having a Wi-Fi™ network installed in the coffee shop). Each network segment owner 150 of a respective network segment 120 enters location and demographic information as registration information for a site where the content insertion engine CIE 100 in the network segment 120 is installed into content control system (CCS) 200. For example, the registration information may include the location of the network segment 150, i.e., the address where the network segment is located (e.g., 123 Maple St. and zip code). Furthermore, the registration information may also include the nature of a site where the network segment is located (e.g., coffee shop, book store, library, college student cafeteria, etc.). The network segment owner NSO 150 also enters a serial number of the content insertion engine CIE 100 into the content control system CCS 200 as registration information. The registration information is entered into the content control system CCS 200 using a web browser over the internet or may also be entered into the content insertion engine CIE 100 over the network segment 120. Hence, the network segment owner NSO 150 may enter the registration information from any point in the internet. The network segment owner NSO 150 is not tied to entering the registration information through the network segment 120 owned by the NSO 150 but can be entered remote from the network segment 120. As a result, the location and demographic information of the network segment can be made available to the content managers.

The content control system CCS 200 sends content to the content insertion engine CIE 100, to be inserted. The content control system CCS 200 sends keywords, content and/or other data from content managers (CM) 400 to CIE 100 over the network (internet or private network) to be matched to webpage keywords and NSO 150 registration data. The content control system CCS 200 matches content and/or demographic information sent from the content insertion engine CIE 100 with content, keywords and demographic information entered by content managers 400.

Content managers 400 (e.g., an advertiser) manage and enter content, keyword, demographic information and offered price, and other content conditions and profile preferences into content control system CCS 200 using a web browser or other interface. The content entered by the content manager 400 is inserted by CIE 100 in web viewing content of web user WU 105 based on market pricing of inserted content for the location and demographic information of the content insertion engine CIE 100 and/or based on the context and/or based on a traffic content profile of the web user WU 105.

One or more system administrators (SA) 205 manages the content control system CCS 200. A unique serial number of the CIE 100 is registered with the CCS so the CCS can identify and associate each CIE 100 with its registration information. For example, the system administrator SA 205 may enter unique serial numbers of each of the content insertion engine CIE 100 into content control system CCS 200 prior to delivery of the CIE 100 to the network segment owner NSO 150. There are different unique serial number schemes and registration schemes for the content insertion engine. The serial number of the content insertion engine CIE 100 can be, for example, a media access control address (MAC address). The MAC address is a unique identifier attached to most forms of networking devices and equipment.

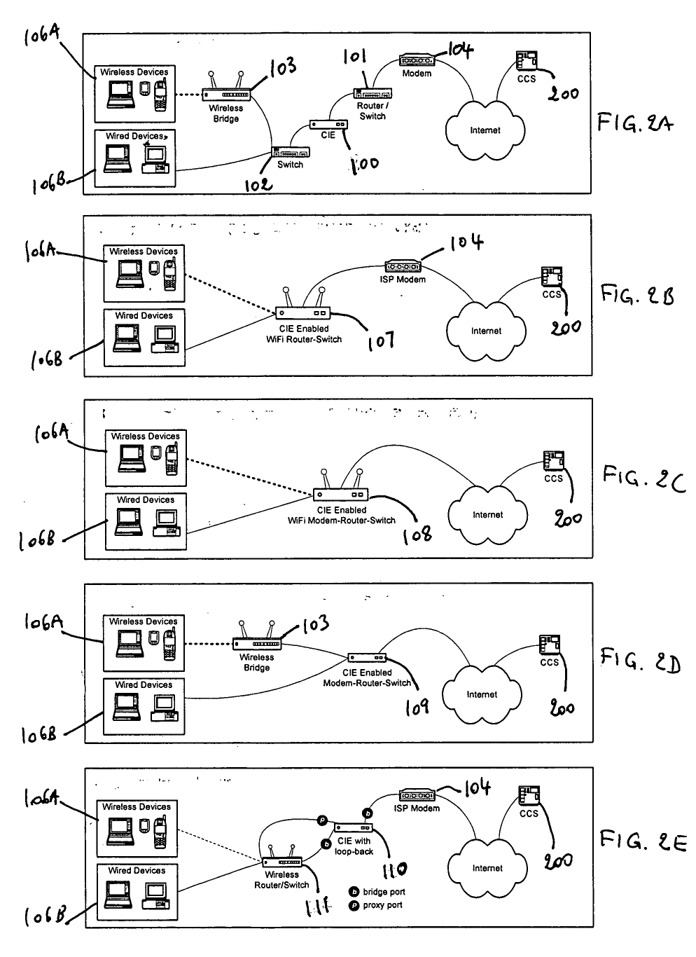

FIGS. 2A-2E depict various configurations of connecting the content insertion engine CIE 100 in the network, according to various embodiments of the present invention. As shown in FIG. 2A, in an embodiment of the invention, the network segment owner NSO 150 connects a port of the content insertion engine CIE 100 to a first switch port 101 (which may be a router or other switch) and connects another port of the content insertion engine CIE 100 to a second switch port 102. In this configuration, the content insertion engine CIE 100 is connected as a bridge between the first switch port 101 and the second switch port 102. The content insertion engine CIE 100 is configured by the network segment owner NSO 150 for internet access. In this configuration, the switch port or router 101 is connected to modem 104 for accessing the internet. The switch port 102 may be connected to wireless bridge 103 to provide a wireless link with wireless devices 106A or may be connected directly via a wire connection to wired devices 106B.

In an embodiment of the invention, the content insertion engine CIE 100 receives its network configuration settings from a dynamic host configuration protocol (DHCP) server. Network settings may be needed by the CIE 100 to communicate with the CCS 200. A serial number of the content insertion engine CIE 100 is sent to the content control system CCS 200. The content control system CCS 200 assigns the previously entered network segment owner NSO 150 registration information to the serial number of the content insertion engine CIE 100. In this configuration, all traffic that is accessing internet web sites (for example, Wi-Fi™ traffic between wireless devices 106A and the internet) passes through the content insertion engine CIE 100.

In FIG. 2A, the content insertion device 100, the router or switch port 101, switch port 102 and wireless bridge 103 are shown as separate devices. However, it must be appreciated that these devices may be combined as desired. For example, FIG. 2B shows a configuration in which the CIE 100 is replaced by a content insertion engine enabled Wi-Fi™ router/switch device 107 that can perform the combined functions described above with respect to the separate devices 100, 101, 102 and 103. That is, the device 107 may function as a content insertion engine and provide a wireless connection via Wi-Fi™ to wireless devices 106A and may also comprise a switching component and provide a wire connection to wired devices 106B via switch. The device 107 may also function as a router and provide access to modem 104. FIG. 2C shows a configuration in which the CIE 100 is replaced by a content insertion engine enabled Wi-Fi™ modem-router/switch device 108 that can perform the combined functions described above with respect to the separate devices 100, 101, 102, 103 and 104. FIG. 2D shows a configuration in which the CIE 100 is replaced by a content insertion engine enabled modem-router/switch device 109 that can perform the combined functions described above with respect to the separate devices 100, 101, 102 and 104.

In another embodiment, the content insertion engine is provided with a loop-back. As shown in FIG. 2E, a first port of CIE 110 is connected to wireless router/switch 111 through bridge port “b”. A second port of CIE 110 is connected to wireless router/switch 111 through proxy port “p”. A third port of CIE 110 is connected to modem 104 through another bridge port “b” for accessing the internet. The “p” port connection is a regular IP address connection to network under router/switch 111. The IP address is on the front side of the proxy as is required by a proxy service to proxy web requests.

In another embodiment, the network segment owner NSO 150 connects one port of the content insertion engine CIE 100 to a router, connects one port to a modem (e.g., DSL or Cable modem), and connects another port (wired or wireless) to network segment 120. Similarly, the content insertion engine CIE 100 may receive settings using the dynamic host configuration protocol (DHCP). A serial number of the CIE 100 is sent to the content control system CCS 200. The CCS 200 assigns the previously entered NSO 150 registration information to the serial number of the content insertion engine CIE 100. The software is deployed on the existing router or gateway.

Another embodiment of the invention, the content insertion engine CIE 100 is deployed and installed within an organization's network where the content managers (CM) 400 are part of the organization. In this embodiment, the content control system CCS 200 is also deployed in the organization's network or is part of the same physical device as the content insertion engine CIE 100.

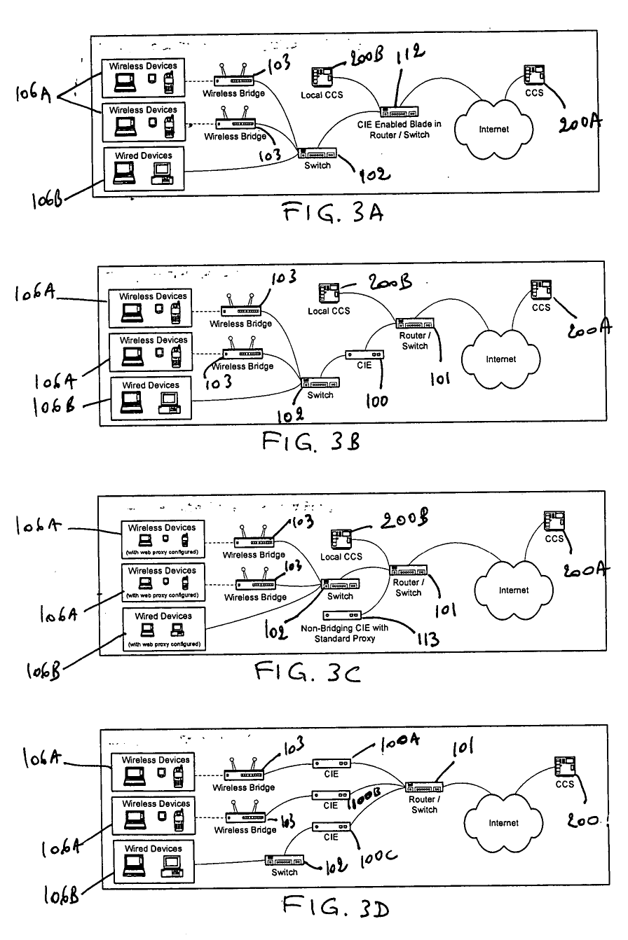

FIGS. 3A-3D depict various configurations of connecting the content insertion engine CIE 100 in the network. As shown in FIG. 3A, in an embodiment of the invention, instead of using a content insertion engine 100, a combined content insertion engine enabled blade router/switch 112 is used. The CIE enabled blade router/switch 112 includes the content insertion functionality, the switch functionality and the router functionality.

For example, in an embodiment of the invention, the CIE functionality is software implemented and is deployed on a modem (such as a DSL modem or cable modem) or router or deployed on a router/Wi-Fi™ access point. As shown in FIG. 3A, a port of the CIE enabled blade router/switch 112 is connected to the internet while another port of the CIE enabled blade router/switch 112 is connected to switch 102. The switch 102 is connected to wireless devices 106A via wireless bridges 103 and connected to wired devices 106B via a wire. In this configuration, there are two content control systems CCS 200A and CCS 200B. The content control system CCS 200A sends content to be inserted, keywords and other registration data from content managers over the internet and the content control system CCS 200B sends content to be inserted, keywords and other registration data from content managers locally without using the internet. CCS 200A is connected to CIE 112 through the internet while CCS 200B is connected directly to CIE 112 without using the internet.

In contrast with the embodiment shown in FIG. 3A, FIG. 3B shows a configuration in which a content insertion engine 100 is used separate from the router switch 101, switch 102 and wireless bridge 103. This configuration is similar in some ways to the configuration depicted in FIG. 2A. However, in this embodiment, two content control systems CCS 200A and CCS 200B are used instead of one CCS. Although two content control systems are depicted, it must be appreciated that any number of content control systems CCS may be used. The content control system CCS 200A sends content to be inserted, keywords and other registration data from content managers over the internet and the content control system CCS 200B sends content to be inserted, keywords and other registration data from content managers locally without using the internet. CCS 200A is connected to CIE 100 through the internet while CCS 200B is connected directly to CIE 100 through router/switch 101 without linking through the internet.

In the embodiments depicted in FIGS. 3A and 3B, the CIE enabled blade router/switch 112 (see FIG. 3A) and the CIE 100 (see FIG. 3B) are in a bridging configuration. In FIG. 3A, CIE enabled blade router/switch 112 is configured as a bridge between the internet and the switch 102. In FIG. 3B, CIE 100 is configured as a bridge between router/switch 101 and switch 102. Thus, the CIE can have two bridge ports so it could be placed inline between any two devices (e.g., a Wi-Fi™ access point and a switch). In this configuration, the IP address of the CIE 100 is on the bridge. The CIE could have three bridge ports. Two ports are used for bridging and one port (wired or wireless) has an IP address connected to the network segment (wired or wireless). On the other hand, in FIG. 3C, the CIE 113 is a non-bridging CIE. In FIG. 3C, the CIE 113 is connected to router/switch 101. Router/switch 101 is connected to switch 102, to local CCS 200B and to the internet.

FIG. 3D depicts a configuration using a plurality of CIEs (e.g., three CIEs 100A, 1001B and 100C), according to an embodiment of the invention. CIEs 100A, 100B and 100C are connected to router/switch 101 which in turn is connected to the internet. CIE 100A is connected to wireless devices 106A through one wireless bridge 103, CIE 1001B is connected to other wireless devices 106A through another wireless bridge 103 and CIE 100C is connected to wired devices 106B through switch 102.

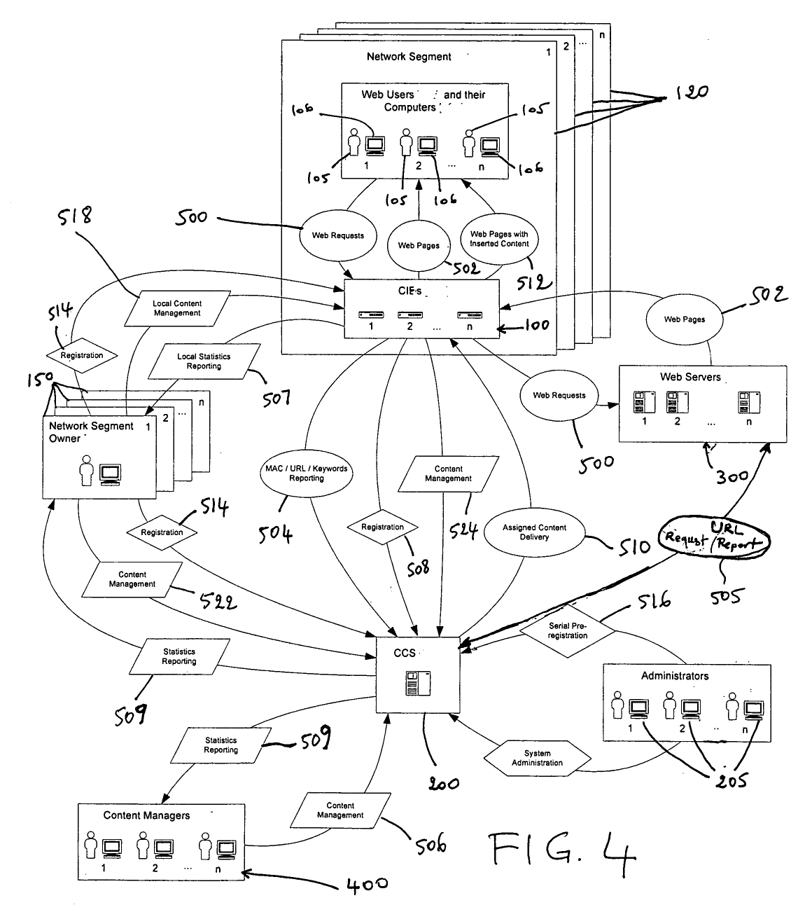

FIG. 4 shows a flow chart depicting a process of insertion, according to an embodiment of the present invention. A web user (WU) 105 on network segment (NS) 120 uses a browser on device 106 (e.g., a computer, a personal digital assistant, etc.) to browse any web site from network segment (NS) 120 by sending web requests 500 to web servers 300 via a network (e.g., the internet). The content insertion engine CIE 100 comprises two software/hardware portions. One portion is dedicated for capturing the requested web pages and an IP address of the user and another portion that is dedicated (for example, via SNMP) to capturing the MAC address of the user's computer 106. For example, the content insertion engine CIE 100 uses transparent proxy (which may be implemented as software or hardware) to capture the requested web pages and the IP address of the user and may use a sniffer or other network software to capture the MAC address of the requesting web user's 105 computer (WUC) 106. The web server returns the requested web pages 502 to the web user 105 via the content insertion engine 100.

In an embodiment, after capturing the requested web pages, the content insertion engine CIE 100 sends the content or the keywords or the link of the requested web page (e.g., a uniform resource locator (URL)) 504 from the requested web pages of the web user 105 to the content control system CCS 200. In an alternate embodiment, CIE 100 can store a cached copy of content to be inserted along with matching parameters for later delivery to the web user 105. The content insertion engine CIE 100 also sends its unique identifier, and sends the MAC address and IP address 504 of web user computer 106 to the content control system CCS 200. The IP address of the web user 105 may be used for contextual content insertion while the MAC address of the user's computer 106 may be used for tracking (for example, tracking the location of the user). CCS 200 receives the web page, the web page keywords and/or URL, MAC address and IP address of web user computer 106. Furthermore, CCS 200 receives the unique identifier of the content insertion engine CIE 100 from CIE 100.

In the case that content control system CCS 200 receives a URL 505 and scans the web page to determine the web page keywords. The CCS 200 matches the web page keywords with keywords entered in content management 506 by content manager CM 400. In addition, the content control system CCS 200 matches demographic information from a site registration data referenced 508 of the content insertion engine CIE 100, using a serial number of the content insertion engine CIE 100 with demographic target information 506 entered by the content manager 400.

The content control system CCS 200 and the content insertion engine 100 communicate a number of different connection schemes. For example, in one embodiment, the content insertion engine CIE 100 periodically contacts the content control system CCS 200 for matched content 510 for delivery to the web user 105. The content insertion engine CIE 100 inserts matched content into the requested pages 512 using transparent proxy (software or hardware) and delivers the combined requested content and inserted content 512 to the web user 105. However it must be appreciate that the requested content may be delivered without inserted content. This may be the case, for example, when the content insertion engine CIE 100 is turned off or in the case where the CIE is merely gathering statistical data about the web users 105 using the network segment 120. The network segment owner 150 of network segment 120 may use the gathered statistical data for marketing purposes or may sell the gathered data to various companies that may be interested in evaluating a particular market segment or the like.

Content manager 400 uses a web browser or other web interface to interact with content control system CCS 200 to store and deliver advertisement content and associated keywords or groups of keywords in the process of content management 506. For example, content manager 400 may restrict specific advertisements to selected geographic regions by entering ranges of zip codes or to particular demographic groups by selecting one or more pre-existing demographic grouping identifiers. In an embodiment of the invention, the advertisement content is matched and inserted in web viewing content of web user WU 105 based on market pricing for the location and demographic information of the content insertion engine CIE 100 and based on the context and traffic content profile of the web user WU 105. The market pricing for inserting web viewing content may be set according to various parameters, including demographics on the CIE 100, set by the network segment owner NSO 150, negotiated between the NSO 150 and content manager 400 and/or determined according to the market.

The content insertion engine CIE 100 may also insert targeted advertisement or other content (e.g., the local weather or other type of information) into the requested web pages being viewed by the web users WU 105 either by directly modifying the web pages before delivery to the web user 105 or by inserting, for example, full-page advertisements between requested web pages.

Each network segment owner 150 which owns a respective network segment enters a location and demographic information as registration information 514 for a site where the content insertion engine CIE 100 in the network segment 120 is installed into content control system (CCS) 200. The network segment owner NSO 150 also enters a serial number of the content insertion engine CIE 100 into the content control system CCS 200 as registration information 514. The registration information 514 is entered into the content control system CCS 200 using a web browser over the internet. The registration information 514 may also be entered into the content insertion engine CIE 100 over the network segment 120.

The system administrator SA 205, which manages the content control system CCS 200, enters unique serial numbers of each of the content insertion engine CIE 100, as serial number pre-registration 516, into content control system CCS 200 prior to delivery each of the content insertion engines CIE 100. The serial number 516 of the content insertion engine CIE 100 can be, for example, a MAC address.

There are different unique serial number schemes and registration schemes for confirming ownership of the content insertion engine CIE 100 by the network segment owner NSO 150. In an embodiment, content insertion engine CIE 100 sends a unique identification to content manager 400. The network segment owner 150 activates the identification by registering another number that is registered with a serial number of CIE 100 on CCS 200. In another embodiment, the network segment owner NSO 150 may use the web registration page on the CIE 100 to register on CCS 200 by sending embedded unique identifications that were recorded before the CIE 100 shipped. In yet another embodiment, the system administrator 205 may register the CIE 100 by contacting the NSO 150, who reads the serial number off a web form from the CIE 100.

The content insertion engine 100 tracks a number of activity statistics, including a number of unique web users 105, a number of pages viewed by each user 105, a number of advertisements delivered to the web user 105, etc. This information is stored locally and sent to CCS 200. The CIE 100 can use this information to provide local Statistics reporting 507 to the NSO. The CCS 200 can use the activity statistics collected from one or more CIEs to provide statistics reporting 509 to content manager 400 and network segment owner NSO 150.

The network segment owner NSO 150 can manage local content 518 directly on the content insertion engine CIE 100 by using a web browser or other interface to store advertisement content and associated keywords or groups of keywords. This managed local content 518 managed by the NSO 150 may stored locally on the CIE 100 or on CCS 200 via content management route 522. Alternatively, the managed content stored on the CIE may delivered to the CCS 200 via route 524.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. Accordingly, all suitable modifications and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method of providing content, comprising:
intercepting data inbound to a user, data outbound from the user or both, the data being intercepted at a network segment;
determining content of interest to the user; and
adding the content of interest to the inbound data.

2. The method according to claim 1, wherein the determining comprises determining the content of interest to the user based on the intercepted data.

3. The method according to claim 1, wherein the intercepting comprises intercepting a web page accessed by the user.

4. The method according to claim 1, wherein the intercepting comprises intercepting a URL of a web page accessed by the user.

5. The method according to claim 4, wherein the determining comprises matching content of interest according to contents corresponding to the URL of the web page.

6. The method according to claim 1, wherein the intercepting comprises intercepting at least one keyword present in a web page accessed by the user.

7. The method according to claim 6, wherein the determining comprises matching content of interest with at least one keyword present in the web page.

8. The method according to claim 1, wherein intercepting comprises capturing an IP address of the user.

9. The method according to claim 1, wherein intercepting comprises capturing a MAC address of a device used by the user to access the data.

10. The method according to claim 1, further comprising storing the data in a content control system.

11. The method according to claim 10, wherein the data stored in the content control system is compared with data provided by a content manager.

12. The method according to claim 11, wherein the data provided by the content manager comprises advertisement content.

13. The method according to claim 1, wherein the data is stored in a content insertion engine local to the network segment.

14. The method according to claim 1, further comprising:
determining a location of the user; and
adding content related to the location of the user to the inbound data.

15. The method according to claim 14, wherein determining the location of the user comprises determining the location of the network segment.

16. The method according to claim 1, further comprising:
determining a location of the user; and
adding content related to demographics target parameters of the location of the user.

17. The method of claim 1, further comprising tracking the location of the user when the location of the user changes.

18. A system for providing content, comprising:
a content insertion engine configured to intercept inbound data, outbound data or both in a network segment; and
a content control system in communication with the content insertion engine; the content control system configured to match the intercepted data with data stored in the content control system,
wherein the content insertion engine is configured to insert the data matched with the intercepted data into the inbound data.

19. The system according to claim 18, wherein the content insertion engine comprises
a sniffer component, the sniffer component being configured to intercept a MAC address of a user connected to the internet via the content insertion engine.

20. The system according to claim 19, wherein the sniffer component is a program executable by the content insertion engine.

21. The system according to claim 19, wherein the sniffer component is a hardware component of the content insertion engine.

22. The system according to claim 18, wherein the content insertion engine comprises a capturing component configured to capture an IP address of a user connected to the internet via the content insertion engine.

23. The system according to claim 18, wherein the data comprises a URL of a web site accessed by a user via the content insertion engine.

24. The system according to claim 18, wherein the data comprises a web page accessed by a user via the content insertion engine.

25. The system according to claim 18, wherein the data is a keyword in a web page accessed by a user via the content insertion engine.

26. The system according to claim 18, wherein the content control system is configured to match a keyword captured by the content insertion engine with keywords stored in the content control system and to deliver content to the content insertion engine corresponding to the matched keywords.

27. The system according to claim 18, wherein the content control system is configured to determine the location of the network segment using data provided by the content insertion engine.

28. The system according to claim 27, wherein the content control system is configured to add content related to a location of the network segment.

29. The system according to claim 18, wherein the content control system is configured to track a location of a user connected to a network segment using a MAC address of a device of the user used to access the internet and using a location of the network segments visited by the user.

30. A method of providing content, comprising:
intercepting data inbound to a user, data outbound from the user or both, the data being intercepted at a network segment; and
adding content of interest to the user to the inbound data.

31. A method of providing content, comprising:
determining content of interest to a user using intercepted inbound data to the user, outbound data from the user, or both;
matching the inbound data, outbound data or both with input data to obtain the content of interest; and
delivering the content of interest to the user.

32. A content insertion engine, comprising:
a sniffer component, the sniffer component being configured to intercept a MAC address of a user connected to the internet via the content insertion engine; and
a capturing component configured to capture an IP address of the user connected to the internet via the content insertion engine; and
an intercepting component configured to intercept content accessed by the user,
wherein the content insertion engine is configured to insert content of interest to the user according to the IP address of the user, the MAC address of the user, the content accessed by the user, or any combination of two or more thereof.

33. A content control system, comprising:
a matching component configured to match a keyword received by the content control system with keywords stored in the content control system and to deliver content corresponding to the matched keywords;
a locating component configured to determine a location of a network segment using data provided by the network segment; and
a tracking component configured to track a location of a user connected to the network segment using a MAC address of a device of the user and using the location of the network segment.
